(19) United States
(12) Patent Application Publication
(10) Pub. No.: US 2008/0184132 A1
(43) Pub. Date: Jul. 31, 2008

(54) MEDIA CONTENT TAGGING

(76) Inventor: Thomas J. Zato, Santa Clara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/669,506

(22) Filed: Jan. 31, 2007

(51) Int. Cl. G06F 3/01

(52) U.S. Cl. 715/748

(57) ABSTRACT

A system comprises control logic and a display coupled to the control logic. The display is adapted to play media content. The control logic retrieves information via a network interface based on viewer selection of a location within a frame of the media content.

### BACKGROUND

With the advent of digital video recorders, viewers are able to record programs (e.g., television broadcasts) for subsequent viewing. Viewers can, and often do, fast-forward through advertisements within the recorded programs. While desirable to at least some viewers, being able to fast-forward through advertisements is undesirable to the advertisers who rely on their advertisements being viewed for future sales, brand recognition, etc.

### BRIEF DESCRIPTION OF THE DRAWINGS

For a detailed description of exemplary embodiments of the invention, reference will now be made to the accompanying drawings in which:

FIG. 1 shows a system in accordance with embodiments of the invention;

FIG. 2 shows a block diagram of a playback device usable in the system of FIG. 1;

FIG. 3 shows a method of embedding tags in media content in accordance with embodiments of the invention; and

FIG. 4 shows a method of playing media content with embedded tags.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. The term “system” refers to a combination of one or more elements.

### DETAILED DESCRIPTION

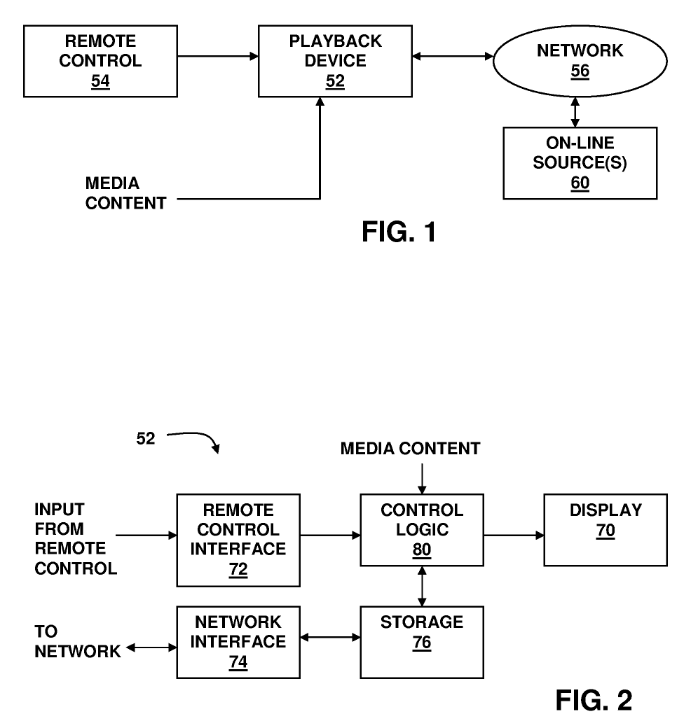

FIG. 1 illustrates a playback device 52 operable by a remote control 54. The playback device 52 plays media content such as that provided by cable broadcasters, satellite broadcasters, etc., or media content stored on an optical disc such as a digital video disc (DVD), local Hard Disk Drive (HDD) or other storage device capable of storing digital media content. The playback device 52 comprises a display such as a plasma television monitor, a liquid crystal display (LCD), etc. The playback device 52 also couples to a network 56. Via the network 56, the playback device 52 can access one or more on-line sources 60. The on-line sources 60 provide information about various objects that are embedded in the media content, and thus displayed on the playback device 52 while the media content is being played. Such information comprises, for example, advertising information about an object of advertising interest (e.g., a cellular telephone) provided in the media content. The media content is processed to contain “tags” that enable the playback device 52 to access the relevant information from an on-line source 60 via network 56.

FIG. 2 illustrates an embodiment of playback device 52. The playback device 52 comprises control logic 80 coupled to a display 70 (e.g., plasma television monitor, etc.), a remote control interface 72, a network interface 74, and storage 76. The storage 76 comprises a computer-readable medium such as volatile memory comprising, for example, random access memory (RAM), non-volatile storage such as a hard disk drive, and combinations thereof. The control logic 80 comprises a processor in accordance with at least some embodiments. The storage 76 comprises software that is executable by the control logic 80 in the embodiment in which the control logic comprises a processor. In such embodiments, the functionality described herein as attributed to the playback device 52 is performed in part or in whole by the control logic 80 executing the software. The storage 76 is also usable for storing other types of information such as information pertaining to the media content as will be explained below.

The network interface 74 is any suitable type of network interface such as Ethernet. The network interface 74 provides the playback device 52 with access to various on-line sites and services.

The remote control interface 72 receives input signals from the remote control 54 (FIG. 1). The communication link between the remote control 54 and the remote control interface 72 can be wireless or wired. Examples of wireless links comprise radio frequency (RF) such as Bluetooth and infrared (IR). The remote control 54 can be used by the viewer to select media content to be played on display 70. Further, the remote control 54 is usable to select a desired location on the display 70 while media content is being played. The user selection of a location on the display 70 can be performed in a variety of different ways. For example, objects in a displayed video frame that are linked to additional information can be either highlighted or shaded, to directly indicate their linkage and are selectable by the remote control 54, or a small icon could be displayed in a corner of the screen indicating additional content is available. The indication of this linkage is not limited to these methods of display. Clicking on the indicated object or icon would then allow the additional information to be displayed on the screen as an overlay, in a Picture-in-Picture (PIP) window, for immediate presentation, or stored by the control logic 80 for review at a later time for convenience.

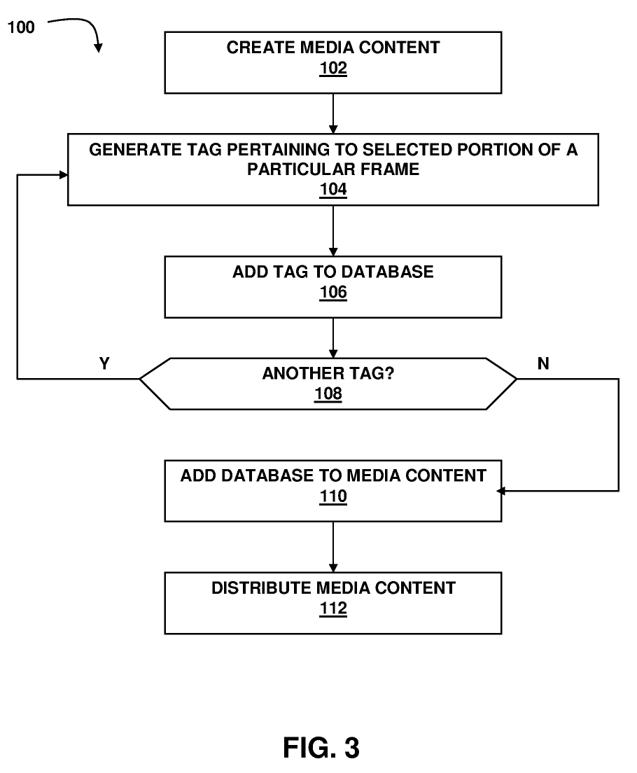

FIG. 3 illustrates a method 100 in accordance with various embodiments. At 102, media content is created by, for example, a television or movie studio. The media content is then analyzed frame by frame for displayable objects that a viewer of the media content might desire to buy or learn more about. Such an object is present in one or more frames at a particular location on the display when the media content is being played. Examples of such objects comprise a particular model of an automobile, a particular brand of clothing, a particular model of a computer, or any other item that a viewer of the media content might desire to buy or learn more about.

At 104 of method 100, a “tag” is generated pertaining to a selected portion of a particular frame of the media content. The selected portion contains an object that is deemed to be of interest to viewers and that viewers would want to buy and/or learn more about. The tag comprises data associated with the specific location (containing the object of interest) of a specific frame or series of frames, of the media content. The tag's data comprises, for example, an identity of the object, an address of an on-line source of information pertaining to the object, a coordinate of the location within the frame at which the object appears, an identity of the frame containing the object, and combinations thereof. Additional or different data can be included within the tag.

The object identity comprises, for example, an alphanumeric value that uniquely identifies the object and distinguishes the object from other object in that and other frames. In some embodiments, the object identity comprises the name of the object (e.g., 2007 Chevrolet Corvette).

The address of the on-line source of information pertaining to the object comprises the Internet Protocol (IP) address or Uniform Resource Locator (URL) of the web site containing the relevant information. The relevant information comprises, for example, advertising information about the object and may also include the ability to directly purchase the item (e.g., an “impulse” purchase).

The coordinate of the location within the frame containing the object comprises, for example, an X,Y coordinate on the display at which the object is located when the frame is displayed. In some embodiments, the coordinate comprises a range of coordinates defining the area of the display containing the object. For example, the coordinate may comprise coordinates of opposite corners of a rectangular area of the display in which the object is displayed.

The frame identity is commensurate with whatever designation is used for each frame. In some embodiments, each successive frame of the media content comprises a sequential number which is used as the frame identity.

Media content is typically presented to the viewer as multiple images every second (e.g., 30 frames per second). Thus, an object that appears in one frame is likely to appear in multiple adjacent frames. For example, a car that appears for five seconds will be present in 150 frames, assuming a frame rate of 30 frames per second. As such, the tag that is generated at 104 for a particular object on a given frame may be applicable to multiple other frames as well. Consequently, in some embodiments, the tag for a given object may be generated for one or more, or all, frames containing that object.

Referring still to FIG. 3, at 106, the tag is added to a database of tags. If it is desired to continuing reviewing frames and adding more tags, the method 100 loops back to action 104 at which an another tag is generated. If the media content has been fully analyzed and/or no more tags are desired for display objects, then at 110 the database of tags is added to the media content. In some embodiments, the database is prepended or appended to the media content. In other embodiments, the database is inserted opportunistically as part of the video stream encoded in the media content or in a caption-like non-display format that is part of embedded metadata similar to the way closed caption data is inserted in a video signal. Additionally, the series of tags and their associated video frames can be transmitted as a monolithic group of data, before the video is received or played back, such that the control logic 80 can associate the tag list with the appropriate video frame as the video frames are received for display. Finally, at 112, the media content, which contains the database of tags, is distributed. Distribution channels comprise, for example, cable television, satellite television, etc.

In some embodiments, all of the actions of method 100 are performed by the same entity (e.g., the movie studio). In other embodiments, however, action 102 (initial creation of the media content) and action 112 (distribution) are performed by one entity (movie studio), while the remaining actions 104-110 are performed by a different, post-processing entity. The post-processing entity performs actions 104-110 for a fee on behalf of the entity that created the media content, or on behalf of advertisers that desire for tags pertaining to objects to be advertised be added to the media content.

Actions 104-110 are performed on, for example, a computer. Such a computer comprises a processor, memory and software executed by the processor for performing actions 104-110.

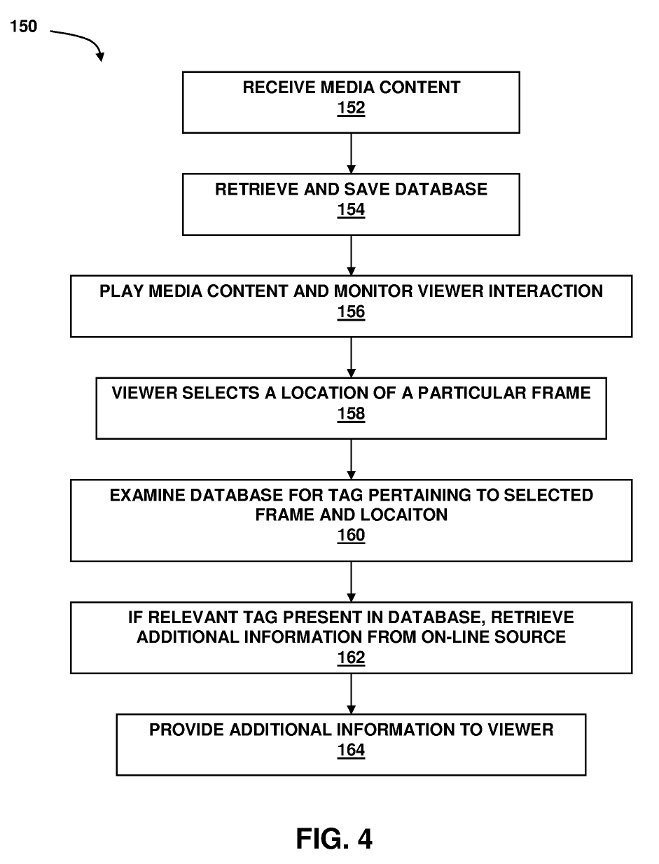

FIG. 4 illustrates a method 150 in accordance with some embodiments for playing the media content created and processed per method 100 of FIG. 3. The various actions depicted in FIG. 4 are performed by the playback device 52. At 152, the playback device 52 receives the media content containing one or more tags. The media content may be received, for example, as a cable or satellite broadcast, or from any suitable form of storage medium (e.g., HDD, DVD, Flash memory, secure digital (SD) card, etc.), or from an optical disc such as a DVD. From the received media content, the control logic 80 associates the tags with the proper video frames, either on-the-fly as the tags are received with the video frames, or by associating the tags received in the monolithic group of data received earlier, with the respective video frame as the video frame arrives. The database of tags is stored in storage 76. At 156, the media content is played (e.g., displayed on display 70). While the media content is being played, viewer interactions via remote control 54 are monitored by the control logic.

While viewing the media content, the viewer may see a particular object on the display that the viewer would like to learn more about and/or possibly purchase. In this case, at 158 the viewer uses the remote control 54 to select the location on the display containing the object of interest. The selection can be performed by, for example, activating a specific button on the remote control 54, to enhance a highlighted object, or simply activating a defined button on the remote control 54 when an icon indicating additional content is available, is present. The selected location corresponds to an area of a particular frame containing the desired object. The control logic 80 determines the coordinate of the display area selected by the viewer. The control logic 80 at 160 examines the database of tags to determine if a tag exists comprising the coordinate selected by the viewer. If such a tag exists (action 162), the control logic retrieves additional information about the target object from an on-line source 60 via the network 56. The address (e.g., IP address, URL) of the on-line source 60 is provided within the tag.

At 164, the on-line information pertaining to the target object is provided to the viewer. In some embodiments, the presentation of the information pertaining to the target object is provided in a separate window on the display while the media content is playing. For example, the control logic 80 implements a picture-in-a-picture (PIP) format in which the media content is presented in one window and the additional object information is provided in another window. The size and shape of the windows can be the same as each other, or different. In other embodiments, the additional object information is superimposed on top of the displayed media content.

In some embodiments, the additional object information is provided to the viewer while the media content is playing. In other embodiments, the control logic 80 stores the additional object information or a value indicating that a particular object/tag was selected by a viewer while viewing the media content. In such embodiments, rather than displaying the additional object information in real-time (i.e., as the media content is being played), the viewer can view the additional object information at a later time. At a later time, the viewer can select, via remote control 54, the additional object information to be presented to the viewer. In some embodiments, via the remote control 54, the viewer is presented with a list of objects which the viewer had selected during the playing of the media content. The viewer can then select one of those objects and the control logic 80 responds by downloading the relevant information from the on-line source 60 or retrieving the relevant information from storage 76 (if such information had already been downloaded).

In some embodiments, the additional object information provided to the viewer about a target object may permit the viewer the ability to purchase the object using remote control 54.

The above discussion is meant to be illustrative of the principles and various embodiments of the present invention. Numerous variations and modifications will become apparent to those skilled in the art once the above disclosure is fully appreciated. For example, the control logic 80 may be located within a television or in a “set top box” coupled to a television. It is intended that the following claims be interpreted to embrace all such variations and modifications.

What is claimed is:

1. A system, comprising:
control logic; and
a display coupled to said control logic, said display adapted to play media content;
wherein said control logic retrieves information via a network interface based on viewer selection of a location within a frame of said media content.

2. The system of claim 1 wherein said control logic causes said display to display said information.

3. The system of claim 1 wherein said control logic stores said information.

4. The system of claim 3 further comprising an interface that permits a viewer to select the information for retrieval and display on said display.

5. The system of claim 1 wherein said media content comprises a tag associated with said location within said frame.

6. The system of claim 5 wherein said tag comprises a coordinate of said location.

7. The system of claim 5 wherein said tag comprises an identity of a displayable object within said frame.

8. The system of claim 5 wherein said tag comprises an identity of said frame.

9. The system of claim 5 wherein said tag comprises an address of an on-line source of information pertaining to an object viewable in said frame, said on-line source accessible via said network interface.

10. The system of claim 1 wherein said information comprises advertising data associated with a displayable object contained in said frame.

11. A system, comprising:
means for playing media content; and
means for automatically retrieving from an on-line source information associated with a displayable object of said media content based on viewer input while viewing said media content.

12. The system of claim 11 wherein said means for automatically retrieving comprises means for detecting viewer selection of a particular location within a frame of said media content.

13. The system of claim 12 wherein said means for automatically retrieving also comprises means for determining an address of said on-line source based on said particular location.

14. The system of claim 12 wherein said means for automatically retrieving also comprises means for retrieving an address of said on-line source from a tag embedded within said media content based on said particular location

15. The system of claim 11 further comprising means for displaying said information while said media content is being played.

16. A method, comprising:
generating a tag associated with a selected portion of a selected frame of media content, said tag comprising information associated with a displayable object contained within said selected frame; and
adding said tag to said media content.

17. The method of claim 16 wherein adding said tag to said media content comprises adding said tag to a database and adding said database to said media content.

18. The method of claim 16 further comprising generating a plurality of tags, each tag associated with a different selected portion of a selected frame of media content.

19. The method of claim 17 wherein adding said tag to said media content comprises adding said plurality of tags to a database and adding said database to said media content.

20. The method of claim 16 wherein generating the tag comprises generating a tag that comprises an on-line address of a source of information associated with said selected portion of the selected frame.
